(19) United States
(12) Patent Application Publication
(10) Pub. No.: US 2012/0155104 A1
(43) Pub. Date: Jun. 21, 2012

(54) MOBILE LIGHTING APPARATUS

(76) Inventor: John Jonker, Ironbark (AU)

(21) Appl. No.: 13/394,039

(22) PCT Filed: Sep. 2, 2010
(86) PCT No.: PCT/AU2010/001132

§ 371 Date: Mar. 2, 2012

(30) Foreign Application Priority Data
Sep. 4, 2009 (AU) 2009904235

(51) Int. Cl. F21V 21/22; H01R 43/00

(52) U.S. Cl. 362/532; 29/825

(57) ABSTRACT

Mobile lighting apparatus (10), including: a base (11); traction means (12, 13) connected to the base and engaging the ground for moving the base; traction drive means (14) connected to the traction means driving the traction means along the ground; a turret (17) mounted on the base for rotating movement relative thereto about a vertical axis (18); turret drive means for driving the turret about the vertical axis; electricity generation means (41) mounted to the turret for rotating movement therewith; an extendable boom (21) pivotally mounted to the turret adjacent its proximal end for movement relative thereto between a lowered position and a raised position; lighting means (31,32) connected to the boom at its distal end (33); and electricity communication means (51) connecting said lighting means to said electricity generation means. Also disclosed is a method of converting a lifting apparatus to the mobile lighting apparatus.

### FIELD OF THE INVENTION

This invention relates to mobile lighting apparatus.

The invention has particular application to mobile lighting apparatus of the type in which an array of lights is mounted to a boom which can be raised when in a desired location or site for directing light onto a selected area and lowered for transport to another desired location or site.

### BACKGROUND OF THE INVENTION

One known mobile lighting apparatus includes a trailer with a boom and an array of lights mounted thereon which can be raised from a lowered position in which the boom is horizontal and can be secured in that position to a raised position in which the boom is vertical and can be secured in the vertical position. Such apparatus provides for operation of the lights only when the boom is in the vertical position and only provides for securement of the boom in either the horizontal or vertical positions.

The present invention is aimed at providing mobile lighting apparatus which can be more easily moved from one site to another. The invention is also aimed at providing mobile lighting apparatus which can supply more powerful lighting at a greater height than previously known mobile lighting apparatus and be relatively easy to raise and lower.

### SUMMARY OF THE INVENTION

With the foregoing in view, the present invention resides broadly in mobile lighting apparatus, including:

a base;

traction means operatively connected to said base and adapted to engage the ground for moving said base relative thereto;

traction drive means operatively connected to said traction means for driving said traction means along the ground;

a turret mounted on said base for pivoting or rotating movement relative thereto about a substantially vertical axis;

turret drive means for driving said turret about said substantially vertical axis;

electricity generation means mounted to said turret for pivoting or rotating movement therewith;

an extendable boom pivotally mounted to said turret at or adjacent its proximal end for movement relative thereto between a lowered position and a raised position;

lighting means operatively connected to said boom at or adjacent its distal end; and

electricity communication means connecting said lighting means to said electricity generation means.

Preferably, said electricity generation means includes an internal combustion engine with an alternator or generator coupled thereto. It is also preferred that said electricity generation means overhang said base such that in use, the electricity generation means is closer to the ground than the turret so that in cases where the traction means sinks into the ground the electricity generation means or a platform on which it is mounted engages the ground and supports the turret.

Preferably, said drive means includes one or more hydraulic motors drivingly connected to the traction means and driven by an internal combustion engine independently of the electricity generation means.

Preferably, said electricity communication means includes a power cable arranged to fold and unfold on a tray or rack mounted to said boom as said boom retracts and extends.

In another aspect, the invention resides broadly in a method of converting lifting apparatus to lighting apparatus as previously described, the lifting apparatus having a base, traction means operatively connected to the base and adapted to engage the ground for moving the base relative thereto and traction drive means operatively connected to the traction means for driving the traction means along the ground, a turret mounted on the base for pivoting or rotating movement relative thereto about a substantially vertical axis and turret drive means for driving the turret about the substantially vertical axis, an extendable boom pivotally mounted at or adjacent its proximal end to the turret for movement relative thereto between a lowered position and a raised position, and a counterweight mounted to said turret to counter the weight of the boom, the method including:

connecting lighting means to said boom at or adjacent its distal end;

removing the counterweight at least in part and mounting electricity generation means to said turret in a predetermined position instead of the removed counterweight; and

electrically connecting the electricity generation means to the lighting means.

Preferably, said predetermined position is selected such that the electricity generation means acts as a suitable counterweight for the boom and the lighting means mounted thereon when fully extended.

The terms “horizontal” and ‘vertical” are intended to describe the orientation of the particular axis or component being referred to when the apparatus is at rest on a level horizontal surface even though the axis or component may not be geometrically exactly vertical or horizontal. Further, such terms are not intended to limit the apparatus to use in any particular orientation.

### BRIEF DESCRIPTION OF THE INVENTION

In order that the invention may be more easily understood and put into practical effect, reference will now be made to the accompanying drawings wherein:

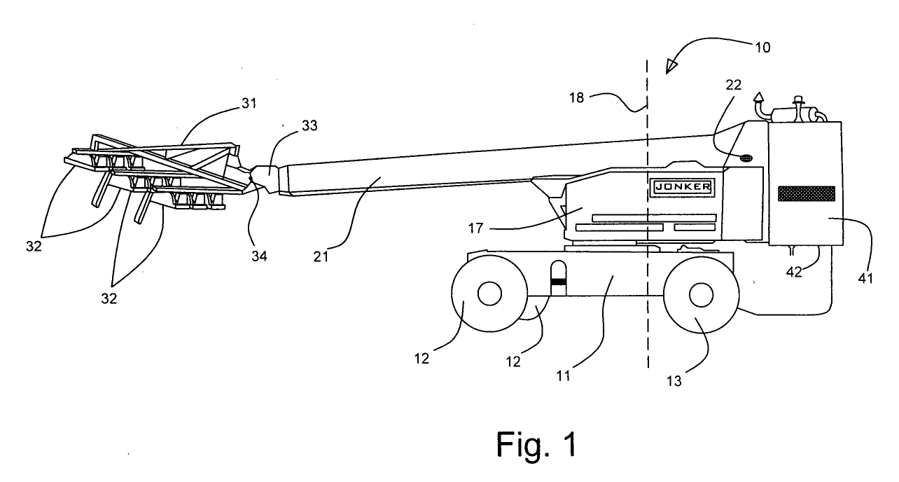

FIG. 1 is a perspective view of lighting apparatus according to the invention from one side with the turret in the travelling position and the boom in the fully lowered position and fully retracted;

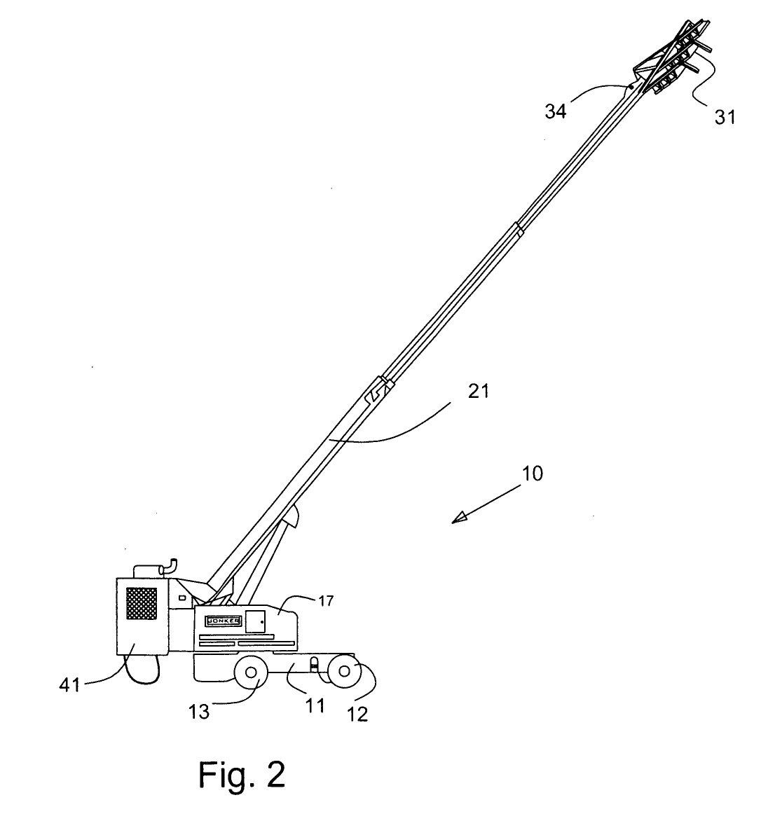

FIG. 2 is a perspective view of the apparatus of FIG. 1 from the other side with the turret in the travelling position and the boom in the partly raised position and fully extended;

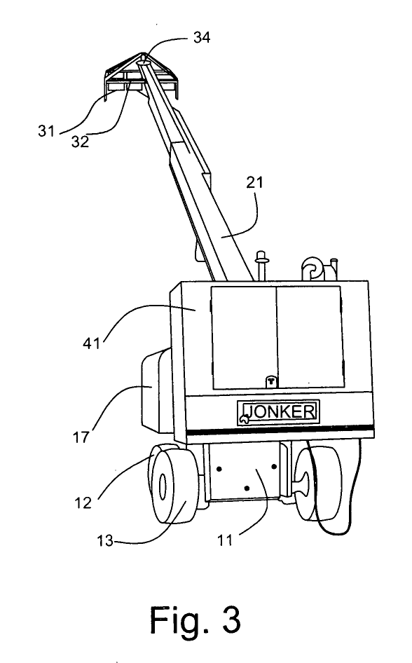

FIG. 3 is a perspective view of the apparatus of FIG. 1 from the rear with the turret in the travelling position and the boom in the same partly raised position and fully extended as in FIG. 2;

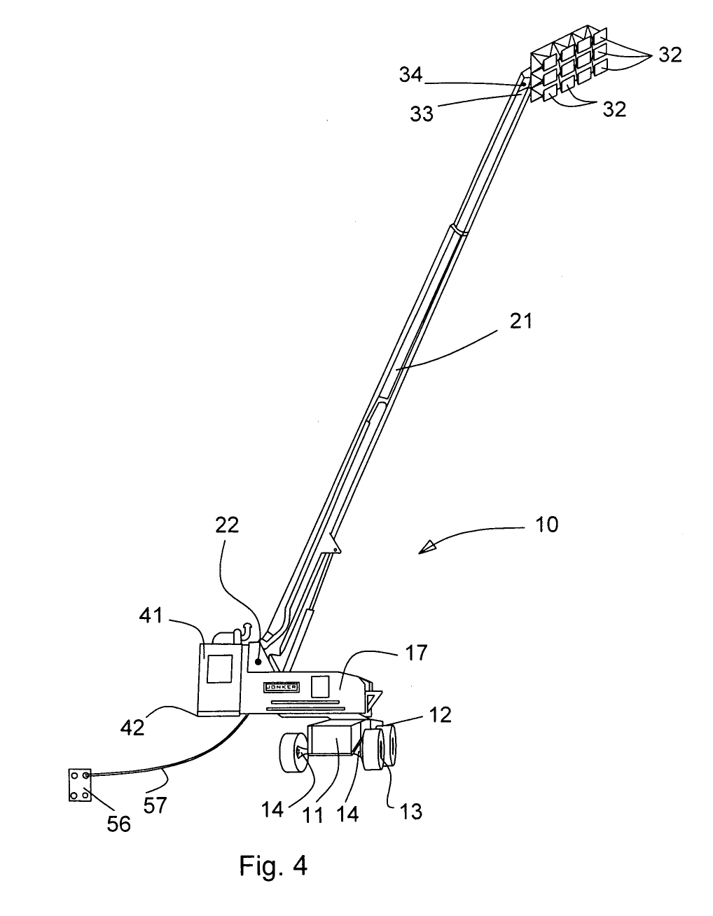

FIG. 4 is a perspective view of the apparatus of FIG. 1 from the rear with the turret turned through ninety degrees from the travelling position and the boom in the almost fully raised position and fully extended.

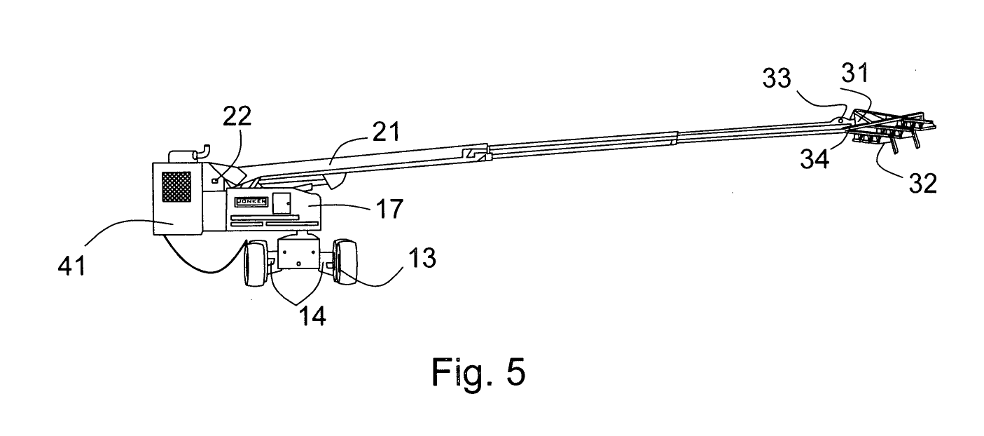

FIG. 5 is a perspective view of the apparatus of FIG. 1 from the rear with the turret turned through ninety degrees from the travelling position and the boom in the almost fully lowered position and fully extended.

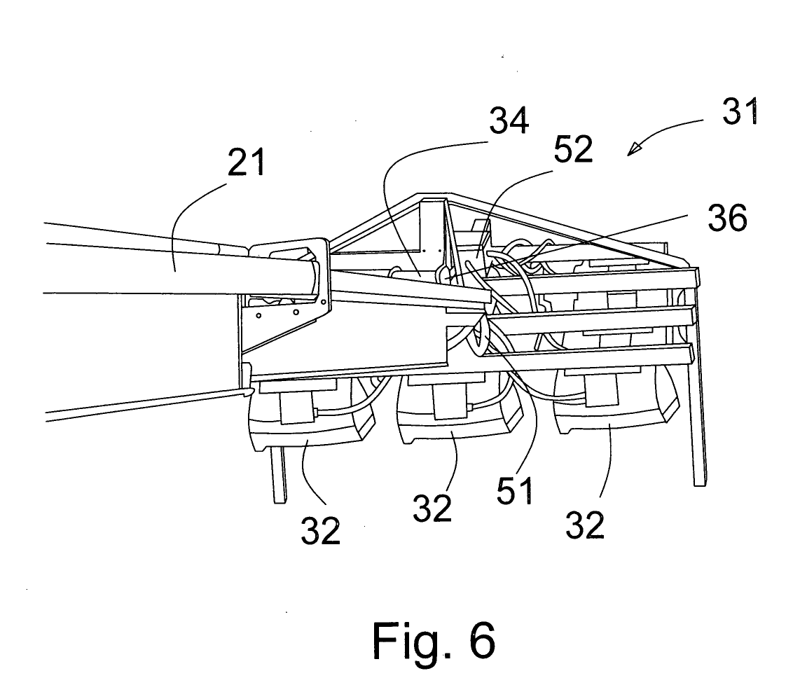

FIG. 6 is a perspective view of the light assembly which is mounted to the outer end of the boom of the apparatus of FIG. 1;

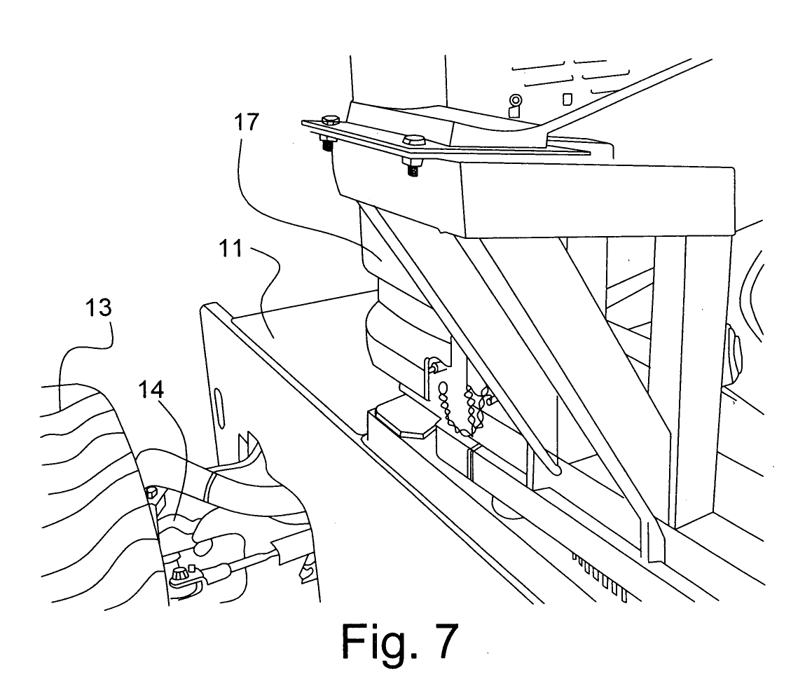

FIG. 7 is a perspective view of the part of the turret showing the generator and the platform on which it is mounted; and

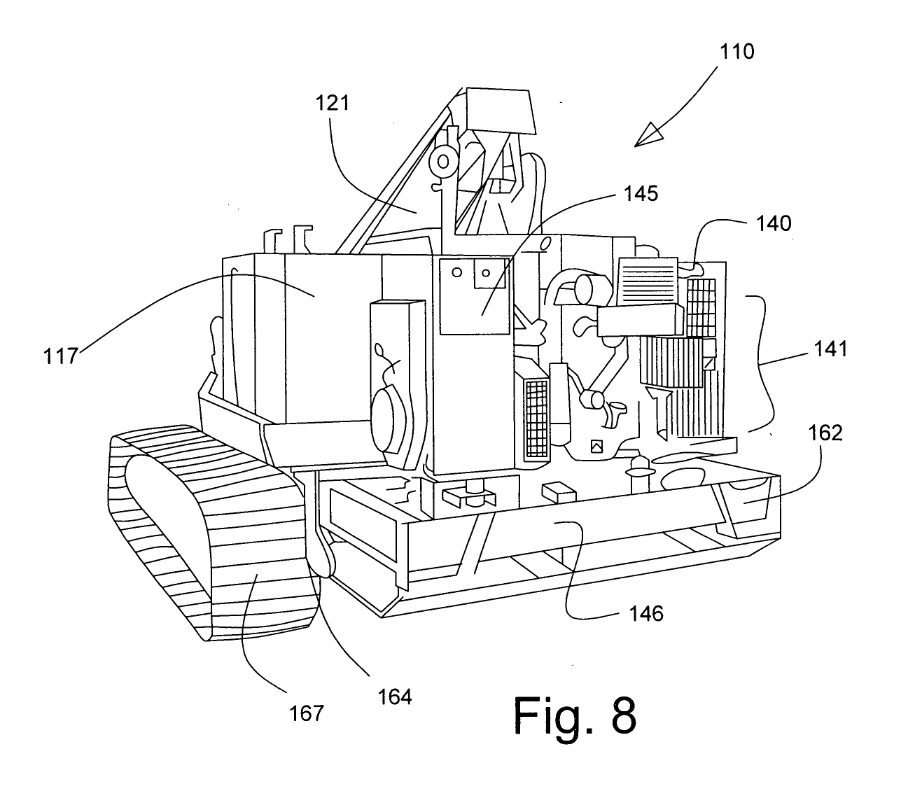

FIG. 8 is a perspective view of part of another lighting apparatus according to the invention from one side with the turret in the travelling position and the boom in the fully lowered position and fully retracted.

### DETAILED DESCRIPTION OF THE INVENTION

The lighting apparatus 10 illustrated in FIG. 1 has been converted from lifting apparatus according to the method previously described. Apparatus 10 includes a base (or chassis) 11 which is supported on two spaced apart front wheels 12 and two spaced apart rear wheels 13 which are drivingly connected to respective hydraulic traction motors 14 in known manner for providing motive power to the wheels. The front wheels are arranged to pivot about respective vertical or inclined axes for steering the apparatus in the usual manner of four wheeled vehicles of this type.

A turret 17 is mounted on the base 11 for pivoting (or rotating) movement about a vertical axis 18 also in known manner for apparatus of this type and driven by a hydraulic motor (not visible in the drawings). An extendable boom 21 is mounted to the turret for up and down movement about a horizontal pivot pin 22 also in known manner for apparatus of this type.

A diesel engine driven hydraulic pump (not visible in the drawings) is mounted in the turret for supplying hydraulic fluid to drive the hydraulic traction motors and the hydraulic motor for pivoting the turret, as well as hydraulic rams for raising, lowering and extending and retracting the boom 21 in known manner.

A lighting frame 31 having an array of lights 32 mounted thereon is connected to the outer end 33 of the boom by a pivot pin 34 for up and down movement relative to the boom with a hydraulic ram 36 arranged to selectively raise and lower the frame.

The lights in the array are powered by a diesel engine driven generator unit 41 which is bolted to a support frame 42 extending from the rear of the turret. Advantageously, the generator unit is mounted in a predetermined position so as to provide a suitable counterweight to the boom, the lighting frame and the lights attached thereto.

A power cable 51 extends from the generator unit 41 on a “cat rack” type tray beside the boom (although in some embodiments it passes through the boom) and is connected at one end to a distribution box 52 mounted on the lighting frame 32. Additional smaller cables distribute power from the distribution box to individual lights 53 mounted on the frame.

The lighting apparatus 110 illustrated in FIG. 8 is similar to the one illustrated in FIG. 1 in many respects and accordingly corresponding features are referenced by corresponding numbers except prefaced by a “1”. In this apparatus, the generator unit 141 is mounted on a steel frame 162 which is connected to the bottom of the turret 117 by two spaced apart steel members 164 welded to the turret at location 165. Additionally, a large foot plate 166 extends fully across the width of the turret under the generator frame and is welded thereto and adapted to support the turret if one or both of the tracks 167 sink too far into the ground. Advantageously, once the turret is supported by the plate 166, the turret and boom can be operated largely in the normal manner irrespective of the base having sunk into the ground. In this apparatus, the protective cover has been removed from the generator unit engine and the engine 140 and close coupled generator 145 can be seen with the fuel tank 146 mounted in the frame 162.

In use, when temporary lighting is required at a site, for example for machinery breakdown repairs, road works, sporting events and the like, the lighting apparatus is transported to the site by truck where it is unloaded via ramps in known manner. The apparatus can then be driven to the desired position under its own motive power by operation of a controller on the turret or by a remote controller connected to the turret by a cable or wireless controller for controlling the engine driven hydraulic pump. When the apparatus is in the desired location, the boom can be raised and extended to a desired elevated position by actuating the relevant control valves and then the generator can be started to supply power to the lights.

In the apparatus illustrated in FIG. 1 the generator unit has a 50 KVA generator and the array of lights require 24 KW so it will be appreciated that the generator has sufficient capacity to provide for a more powerful array of lights if desired. The boom of the apparatus illustrated is selected to be able to hold the array of lights at a height of approximately 20 metres above the ground. However, apparatus of greater or lesser lighting power and greater or lesser boom length could be constructed if desired.

The foregoing description has been given by way of illustrative example of the invention and many modifications and variations which will be apparent to persons skilled in the art may be made without departing from the spirit and scope of the invention as defined by the appended claims.

We claim:

1. Mobile lighting apparatus, including:
a base;
traction means operatively connected to said base and adapted to engage the ground for moving said base relative thereto;
traction drive means operatively connected to said traction means for driving said traction means along the ground;
a turret mounted on said base for pivoting or rotating movement relative thereto about a substantially vertical axis;
turret drive means for driving said turret about said substantially vertical axis;
electricity generation means mounted to said turret for pivoting or rotating movement therewith;
an extendable boom pivotally mounted to said turret at or adjacent its proximal end for movement relative thereto between a lowered position and a raised position;
lighting means operatively connected to said boom at or adjacent its distal end; and
electricity communication means connecting said electricity generation means electricity generation means to said lighting means for transmitting electricity thereto for powering said lighting means;
wherein said electricity generation means includes an internal combustion engine with an alternator or generator coupled thereto and said traction drive means includes one or more hydraulic motors drivingly connected to said traction means and driven by another internal combustion engine.

2. Mobile lighting apparatus according to claim 1, wherein in use said electricity generation means overhangs said base.

3. Mobile lighting apparatus according to claim 1, wherein said electricity generation means is mounted on a platform which overhangs said base.

4. Mobile lighting apparatus according to claim 3, wherein said platform is arranged to engage the ground so as to support said turret upon said traction means sinking to a predetermined depth.

5. (canceled)

6. (canceled)

7. Mobile lighting apparatus according claim 1, wherein said electricity communication means includes a power cable arranged to fold and unfold on a tray or rack mounted to said boom as said boom retracts and extends.

8. A method of converting a lifting apparatus to lighting apparatus, said lifting apparatus having a base, traction means operatively connected to said base and adapted to engage the ground for moving said base relative thereto, and traction drive means operatively connected to said traction means for driving said traction means along the ground, a turret mounted on said base for pivoting or rotating movement relative thereto about a substantially vertical axis and turret drive means for driving said turret about the substantially vertical axis, an extendable boom pivotally mounted at or adjacent its proximal end to said turret for movement relative thereto between a lowered position and a raised position, and a counterweight mounted to said turret to counter the weight of said boom, the method comprising:
connecting lighting means to said boom at or adjacent its distal end;
removing said counterweight at least in part and mounting electricity generation means to said turret in a predetermined position instead of said removed counterweight; and
electrically connecting said electricity generation means to said lighting means.

9. The method according to claim 8, wherein said predetermined position of said electricity generation means is selected such that said electricity generation means acts as a suitable counterweight for said boom and said lighting means mounted thereon when fully extended.

10. (canceled)

11. (canceled)

12. Mobile lighting apparatus according to claim 1, wherein said lighting means includes a frame and an array of lights is mounted on said frame.

13. Mobile lighting apparatus according to claim 7, wherein said electricity communication means is mounted on a rack having a centre line and said rack is adapted to fold and unfold while maintaining said centre line in the same vertical plane.

14. Mobile lighting apparatus according to claim 1, wherein said lighting means includes a frame which is connected to said boom for pivoting movement up and down relative thereto and said pivoting movement is actuated by one or more hydraulic rams.

15. Mobile lighting apparatus according to claim 1, wherein said lighting means includes a frame and an array of lights is mounted on said frame.

16. The method according to claim 8, wherein said predetermined position of said electricity generation means is selected such that said electricity generation means acts as a suitable counterweight for said boom and said lighting means mounted thereon when fully extended.

17. The method according to claim 8, wherein said lighting means includes a frame which is connected to said boom for pivoting movement up and down relative thereto and said pivoting movement is actuated by one or more hydraulic rams.

18. The method according to claim 8, wherein said lighting means includes a frame and an array of lights is mounted on said frame.

19. A method of converting a lifting apparatus to lighting apparatus, said lifting apparatus having a base, traction means operatively connected to said base and adapted to engage the ground for moving said base relative thereto, and traction drive means operatively connected to said traction means for driving said traction means along the ground, a turret mounted on said base for pivoting or rotating movement relative thereto about a substantially vertical axis, and turret drive means for driving said turret about the substantially vertical axis, an extendable boom pivotally mounted at or adjacent its proximal end to said turret for movement relative thereto between a lowered position and a raised position, and a counterweight mounted to said turret to counter the weight of said boom, the method comprising:
connecting lighting means to said boom at or adjacent its distal end, said lighting means including a frame which is connected to said boom for pivoting up and down movement relative thereto, said pivoting movement being activated by one or more hydraulic rams;
removing said counterweight at least in part and mounting electricity generation means to said turret in a predetermined position in place of said removed counterweight, said electricity generation means being capable of acting as a suitable counterweight for said boom and said lighting means mounted thereon; and
electrically connecting said electricity generation means to said lighting means.

20. Mobile lighting apparatus, including:
a base;
traction means operatively connected to said base and adapted to engage the ground for moving said base relative thereto;
traction drive means operatively connected to said traction means for driving said traction means along the ground;
a turret mounted on said base for pivoting or rotating movement relative thereto about a substantially vertical axis;
turret drive means for driving said turret about said substantially vertical axis;
electricity generation means mounted to said turret for pivoting or rotating movement therewith, said electricity generation means being capable of acting as a suitable counterweight for said boom and said lighting means mounted thereon;
an extendable boom pivotally mounted to said turret at or adjacent its proximal end for movement relative thereto between a lowered position and a raised position;
lighting means operatively connected to said boom at or adjacent its distal end, said lighting means including a frame which is connected to said boom for pivoting up and down movement relative thereto, said pivoting movement being activated by one or more hydraulic rams; and
electricity communication means connecting said electricity generation means to said lighting means for transmitting electricity thereto for powering said lighting means;
wherein said electricity generation means includes an internal combustion engine with an alternator or generator coupled thereto and said traction drive means includes one or more hydraulic motors drivingly connected to said traction means and driven by another internal combustion engine.
